(19) United States
(12) Patent Application Publication
(10) Pub. No.: US 2005/0065946 A1
(43) Pub. Date: Mar. 24, 2005

(54) Method for finding files in a logical file system

(76) Inventors: Gu Shao-Hong, Beijing (CN); Rao Hong, Beijing (CN); Tan Wei Len, Beijing (CN); Zhou Jing-Ze, Beijing (CN)

Correspondence Address: MOTOROLA INC, 600 NORTH US HIGHWAY 45, ROOM AS437, LIBERTYVILLE, IL, 60048-5343, US

(21) Appl. No.: 10/942,400

(22) Filed: Sep. 16, 2004

(30) Foreign Application Priority Data
Sep. 23, 2003 (CN) 03132699.4

(51) Int. Cl. G06F 17/00

(52) U.S. Cl. 707/100

(57) ABSTRACT

A method for finding files in a logical file system (120) such as a flash memory module operatively connected to a virtual file system (115) of an operating system (110), the logical file system (120) including a first link point structure. Sectors of a memory layout of the logical file system (120) are exposed in a first link point structure. (Step 220.) The logical file system (120) is then searched beginning at a sector identified in the first link point structure. (Step 240.) Optionally, the method of the invention may include exposing sectors of a memory layout of the logical file system (120) in a plurality of link point structures.

### FIELD OF THE INVENTION

The invention relates generally to a method for finding files in a logical file system's memory layout. The invention is particularly useful for, but not necessarily limited to, exposing a logical file system's memory layout to an operating system to improve the efficiency of the logical file system.

### BACKGROUND OF THE INVENTION

Modern computer operating systems generally include a Virtual File System (VFS) that organizes and catalogues all files that are connected to the system. When new hardware such as an additional memory module is connected to the system, the VFS establishes an interface with the new hardware's logical file system that connects the new hardware into the existing file system hierarchy at a mount point. Mount points are generally just empty directories. After the new hardware is mounted at a mount point, the file tree of the new hardware's logical file system may be accessed through the mount point directory.

In some operating systems, the VFS maintains information about all files in the file system using special pointers called inodes. Inodes are code segments that contain the specific address of where data in a particular file is stored. A VFS directory is thus simply a type of file that includes names of other files and the related inodes that point to the locations of the other files.

Sometimes however the VFS does not understand an attached logical file system's internal architecture, and similarly the logical file system does not understand the VFS's architecture and the related kernel exclusive mutex mechanism. That creates two problems that can both significantly reduce the performance and stability of the system. First, the logical file manager of the logical file system needs to manage all mutex-conflictions by itself. That results in very inefficient data transfer. Second, because the VFS is not familiar with the logical file system tree, when the VFS needs to locate a file in the logical file system it must commence a comprehensive search of the logical file system beginning at the mount point. That results in a lot of unnecessary data being read from the logical file system, which again reduces system performance.

Due in part to the problems described above, the standard Linux virtual file system (VFS) is not able to communicate effectively with certain hardware such as flash memory modules. The Linux operating system is used in numerous types of consumer electronics including mobile phones, personal digital assistants (PDAs), HDTVs, digital video recorders (DVRs), automotive communications systems, advanced remote controls, printers, etc. OEM's often selects Linux because it is a mature, stable and open operating system platform that supports numerous key architectures and technologies.

Referring to FIG. 1, there is a schematic diagram illustrating the prior art hardware and software components of an application such as a mobile phone including programmable flash memory. The arrows indicate the flow of information such as requests from the high level application 105 down through various sublayers. First, information passes through the operating system 110 including the VFS 115. Next information flows through the logical file system 120 including an operating system interface 125 such as a VFS wrapper layer, a file system driver 130, a flash media manager (FMM) 135, and a low-level driver 140. Finally, information reaches the actual programmable flash memory hardware 145.

Where the operating system 110 is Linux, the Linux kernel supplies an inode structure to the VFS 115 that is designed to maintain information about the structure of the logical file system 120. However, for the reasons described above, the operating system 110 may not understand the internal architecture of the logical file system 120 and the inode structure supplied to the VFS 115 may not contain detailed location information concerning files in the logical file system 120.

There is therefore a need for a method for exposing a logical file system's memory layout to a related VFS 115 to increase the efficiency of the logical file system 120 and to increase the stability of the logical file system 120.

### SUMMARY OF THE INVENTION

According to one aspect, the present invention is a method for finding files in a logical file system operatively connected to a virtual file system of an operating system, said logical file system comprising a first link point structure, said method comprising the steps of: exposing sectors of a memory layout of said logical file system in said first link point structure, and searching said logical file system beginning at a sector identified in said first link point structure.

The method may also include the step of exposing sectors of a memory layout of said logical file system in a plurality of link point structures.

The step of exposing sectors of a memory layout of said logical file system in a plurality of link point structures may comprise storing a memory layout of a sub-directory in said sub-directory's link point structure.

The method may also comprise the steps of: receiving a plurality of look up requests from said virtual file system in said logical file system, and finding a file identified in one of said plurality of look up requests. The logical file system may be a flash memory system.

The link point structure may be a “vfm_inode_info” structure.

The step of exposing sectors of a memory layout of said logical file system may comprise storing an FNT sector and an FET sector in said “vfm_inode_info” structure.

The operating system may be a Linux operating system.

### BRIEF DESCRIPTION OF THE DRAWINGS

In order that the invention may be readily understood and put into practical effect, reference will now be made to a preferred embodiment as illustrated with reference to the accompanying drawings, wherein like reference numbers refer to like elements, in which:

FIG. 1 is a schematic diagram illustrating the prior art hardware and software components of an application such as a mobile phone including programmable flash memory;

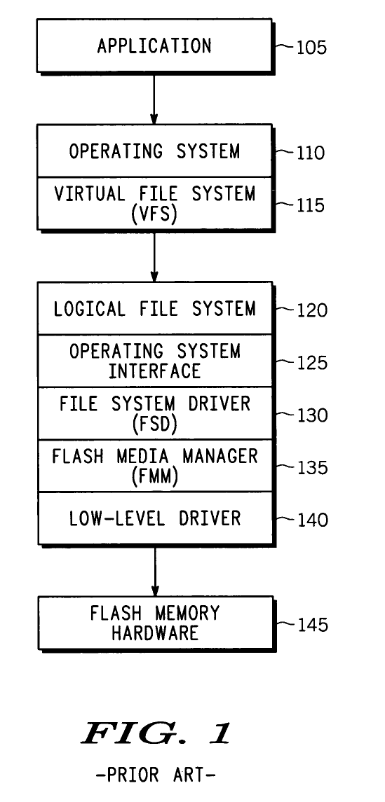

FIG. 2 is a flow diagram illustrating a method for finding files in a logical file system according to the present invention;

FIG. 3 is a schematic diagram of components of a directory tree of a logical file system; and

FIG. 4 is a schematic diagram of the inode structure of a directory according to the present invention.

### DETAILED DESCRIPTION OF THE PREFERRED EMBODIMENT OF THE INVENTION

An embodiment of the present invention is now described with reference to the Linux operating system interfacing with the Virtual Small Block File Manager (VFM) developed by the Intel Corporation. Those skilled in the art will recognize however that the present invention may be adapted to any modern operating system. For interfacing with Intel's (registered trademark) flash memory, inodes may include a “vfm_inode_info” link point structure designed to retain private information of the logical file system 120, such as file location information concerning the file tree structure of the logical file system 120. However, when the logical file system 120 is unable to export its file location information to the VFS 115, any request from the VFS 115 to retrieve files from the flash memory 145 will force the logical file system 120 to begin searching the flash memory file tree from the mount point of the flash memory hardware 145.

When the VFS 115 submits a file lookup request to the logical file system 120, the logical file system 120 first attempts to locate the file according to information contained in the link point structure. In the VFM, the link point structure is the “vfm_inode_info” structure. When searching a path, e.g., “/usr/src/linux/Makefile”, the VFS 115 conducts a search procedure that divides the path into several short searches that search for a file only in an immediate parent directory. For example, in the path described above, even though the actual search request is looking for the file “Makefile” under “usr/src/linux”, the VFS 115 will divide the search into separate short searches and submit four separate lookup requests to the logical file system 120. The first lookup request will locate the “usr” directory from the mount point (“/”); the second lookup request will locate the “src” sub-directory in the “usr” directory; the third lookup request will locate the “linux” sub-directory in the “src” sub-directory; and finally the fourth lookup request will locate the file “Makefile” in the “linux” sub-directory.

According to the present invention, and again with reference to the above search example, when the first lookup request attempts to locate the “usr” directory from the mount point (“/”), the memory layout of the mount point is stored in the mount point's “vfm_inode_info” structure. The logical file system 120 will read out the appropriate sector related to the mount point and search the “usr” directory in that sector. When the “usr” directory is located, the memory layout of the “usr” directory will be stored in the “usr” directory's “vfm_inode_info” structure. Following the second lookup request for the “src” sub-directory in the “usr” directory, the logical file system 120 will find the memory layout of the “usr” directory in the “usr” directory's “vfm_inode_info” structure. The logical file system 120 will then read the appropriate sector from the flash memory hardware 145 and search for the “src” sub-directory in that sector. Similarly, the subsequent lookup requests for the “linux” sub-directory and the file “Makefile” are also performed in the efficient manner described above.

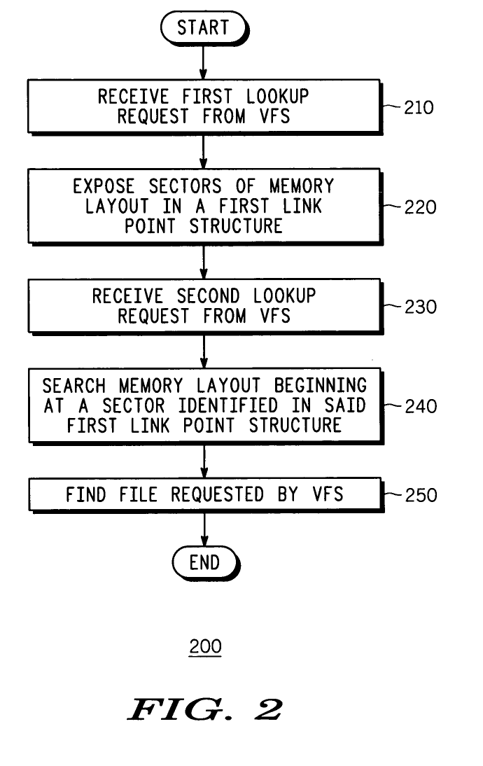

Referring to FIG. 2, a flow diagram is provided illustrating a method 200 for finding files in a logical file system 120 according to the present invention. At step 210 the logical file system 120 receives a first look up request from the VFS 115 for a first sub-directory. When the sub-directory is located, at step 220 the logical file system 120 exposes the sectors of the memory layout of the first subdirectory in the first subdirectory's link point structure. At step 230, the logical file system 120 receives a second look up request from the VFS 115 for a second sub-directory. Next, at step 240, the logical file system 120 searches the memory layout of the first sub-directory beginning at a sector identified in the link point structure of the first sub-directory. The above steps of the method 200 may then be repeated through numerous subdirectories until, at step 250, a file requested by the VFS 115 is found.

According to the prior art, and referring again to the search example above, the first lookup request would search the “usr” directory from the mount point. The logical file system 120 would know the memory layout related to the mount point, so the logical file system 120 could read out the mount point sector and look up the “usr” directory. That step is thus efficient; however, next the “usr” directory's “vfm_inode_info” structure would be created in RAM, but the “usr” directory's memory layout would not be stored in the “vfm_inode_info” structure. Therefore following the second lookup request for the “src” sub-directory, the logical file system 120 would access the “usr” directory's “vfm_inode info” structure but would not find the “usr” directory's memory layout. So the search would start from the mount point, then proceed through the “usr” directory and finally to the “src” sub-directory. The “src” sub-directory's “vfm_inode_info” structure would then be created in RAM, but the “src” sub-directory's memory layout would not be stored in the “vfm_inode_info” structure. Each lookup request would therefore proceed from the mount point until the file “Makefile” is found in the “linux” sub-directory. The above duplicated look up operations are inefficient and can significantly reduce the performance of the logical file system 120, particularly concerning “deep” search requests that involve numerous nested sub-directories.

According to one embodiment of the present invention using the above VFM, the “vfm_inode_info” structure may be modified by adding an FNT_VSB location and a #1 FIT_VSB or a #1 FET_VSB location. That exposes sectors of the memory layout of the flash memory hardware 145. Then the VFS 115 is able to search the target directory directly from the parent directory, because the parent directory's #1 FET_VSB location is saved in the parent directory's “vfm_inode_info” structure. VSB stands for Virtual Small Block, or sector. It is a logical storage unit that consists of a user defined number of bytes. The flash memory hardware 145 is divided up into a number of VSBs. FET stands for File Entry Table. It is a sequentially ordered control structure supporting VFM file entries. FIT stands for File Information Table. It is a sequentially ordered control structure supporting a particular file's data entries. The FET_VSB is thus a VSB containing the File Entry Table with an entry for the current file. The FIT_VSB field is a VSB in a component containing the initial File Information Table structure for a file. FIT_VSB contains the initial File Information Table structure for the file. FNT stands for File Name Table, and the FNT_VSB field is a VSB that includes file name data and other file system meta data.

Therefore the “vfm_inode_info” structure is modified so that a file can be searched from its parent directory rather than from the mount point. According to the above, the “vfm_inode_info” structure according to the present invention may be defined as follows:

```
struct vfm_inode_info {
  struct semaphore sem; /* Mutual exclusion for the file handle mess
        and for the operations which must seek/read
        or seek/write because VFM lacks pread/pwrite */
  WORD handle; /* FSD File handle -- VFM cannot handle
multiple opens */
  int nr_opens; /* Use count for above. */
  VSB_OFFSET fnt_vsb; //The FileNameTable Sector
  VSB_OFFSET fit_vsb; //The first FIT_VSB (or FET_VSB) in file's
FIT chain (or directory's FET chain)
  BYTE valid; // keep the consistance with data in RFA //
};
```

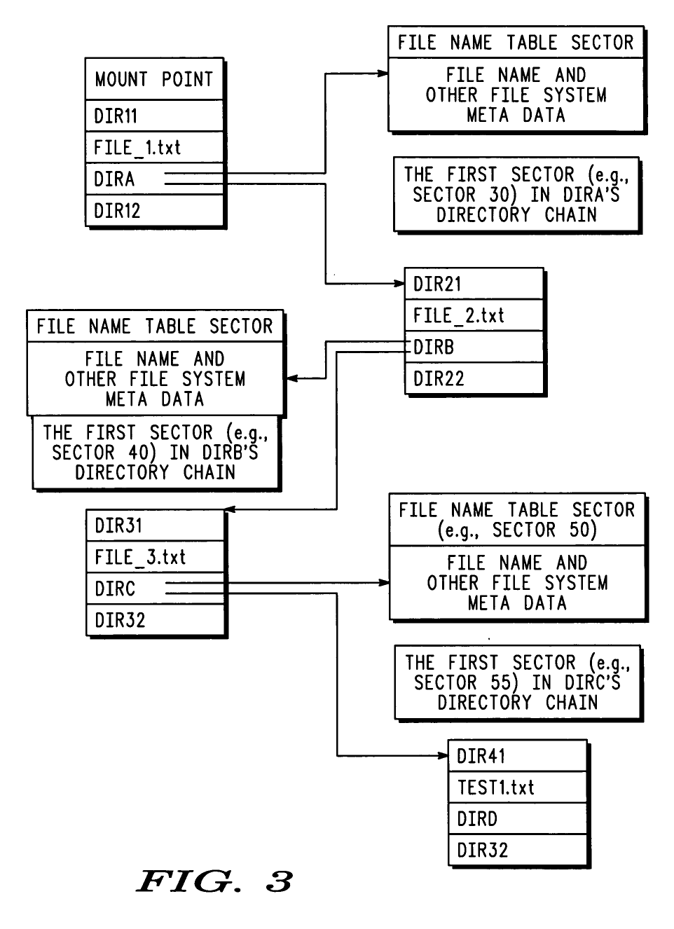

Referring to FIG. 3, there is illustrated a schematic diagram of components of a directory tree of a logical file system 120. Based on the above “vfm_inode info” structure, the VFS 115 can search any element (directory, file or symlink) from the element's parent directory and does not need to start from mount point. For example, the VFS 115 can search for the file named “test1.txt” immediately from the directory “DirC” rather than from the mount point.

FIG. 3 also illustrates that, under the prior art “vfm_inode_info” structure, the VFS 115 would have to search from the mount point and proceed from “DirA” to “DirB” to “DirC” before finding the file “test1.txt”. That is because the memory layout information for “DirC” was not stored in the related “vfm_inode_info” structure.

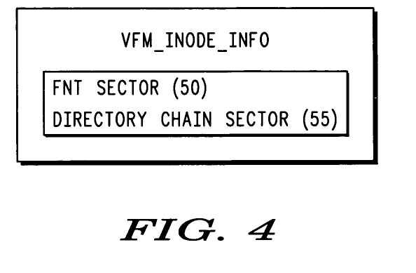

Referring to FIG. 4, there is illustrated a schematic diagram of the inode structure of the directory “DirC” described with reference to FIG. 3 above. The inode structure of “DirC” illustrates that the VFS 115 is able to search for the file “test1.txt” directly from sector 55, which is the directory chain sector of “DirC”. The memory layout information in the “vfm_inode_info” structure includes the directory's File Name Table (FNT) sector and the directory's File Entry Table (FET) chain sector.

The present invention is therefore a more efficient method for finding files in a logical file system 120. By exposing the private information of a logical file system 120, such as file location information, the present invention provides a shortcut through which an operating system 110 can efficiently search a logical file system 120. The increased efficiency of the method of the present invention is multiplied when the method is applied to logical file systems 120 having numerous nested subdirectories.

The above detailed description provides a preferred exemplary embodiment only, and is not intended to limit the scope, applicability, or configuration of the present invention. Rather, the detailed description of the preferred exemplary embodiment provides those skilled in the art with an enabling description for implementing the preferred exemplary embodiment of the invention. It should be understood that various changes can be made in the function and arrangement of elements and steps without departing from the spirit and scope of the invention as set forth in the appended claims.

1. A method for finding files in a logical file system operatively connected to a virtual file system of an operating system, said logical file system comprising a first link point structure, said method comprising the steps of:
exposing sectors of a memory layout of said logical file system in said first link point structure; and
searching said logical file system beginning at a sector identified in said first link point structure.

2. The method of claim 1, further comprising the step of exposing sectors of a memory layout of said logical file system in a plurality of link point structures.

3. The method of claim 2, wherein said step of exposing sectors of a memory layout of said logical file system in a plurality of link point structures comprises storing a memory layout of a sub-directory in said sub-directory's link point structure.

4. The method of claim 3, further comprising the steps of:
receiving in said logical file system a plurality of look up requests from said virtual file system; and
finding a file identified in one of said plurality of look up requests.

5. The method of claim 1, wherein said logical file system is a flash memory system.

6. The method of claim 1, wherein said link point structure is a “vfm_inode_info” structure.

7. The method of claim 6, wherein said step of exposing sectors of a memory layout of said logical file system comprises storing an FNT sector and an FET sector in said “vfm_inode_info” structure.

8. The method of claim 1, wherein said operating system is a Linux operating system.
